(19) United States
(12) Patent Application Publication
(10) Pub. No.: US 2007/0255464 A1
(43) Pub. Date: Nov. 1, 2007

(54) Car intelligence

(76) Inventors: Amita Singh, Yonkers, NY (US); Amit Bhri, Yonkers, NY (US)

Correspondence Address: AMITA SINGH, APT#2, 2238 CENTRAL PARK AVE, YONKERS, NY, 10710, US

(21) Appl. No.: 11/411,472

(22) Filed: Apr. 26, 2006

(51) Int. Cl. G06F 7/00

(52) U.S. Cl. 701/36

(57) ABSTRACT

The purpose of the current is to develop an intelligent vehicle that allows multiple drivers to drive the vehicle and provides customized settings and services for each of them. This is done by making the user profiles for multiple drivers in the vehicle and each driver will be recognized with their finger impression scan. Each driver will scan their finger impression to gain access to the vehicle. When the vehicle will identify the driver from the finger impression, it will load the settings like seat arrangement, mirror position, temperature of the vehicle and the steering wheel of the vehicle according to the settings required by the particular driver. It will also load the personal address list for the driver for use by GPS, personal telephone list for the driver, personal music list for the driver and personalized electronic mail application for the driver. Each driver of the same vehicle will be able to maintain their personal settings of the vehicle and will maintain personal lists of various functions. In this manner each driver will be able to use the vehicle as a distinguished user by loading their personal settings right before entering the vehicle.

### BACKGROUND OF THE INVENTION

The vehicles have been long used as a means of transportation. But in the recent years, vehicle manufacturing has undergone tremendous changes and there have been efforts to make life easy for the users of the vehicle. The features like Global positioning system, music and calling have been the foremost factors to provide comfort to the vehicle owners around the world. More automation efforts are also being input by the companies to provide ready-to-use features for the driver.

There also have been some major concerns about the security of the vehicle and the use of a single vehicle by different drivers. The preferences used by one driver are not suitable to the other driver. In the case of telephone list, the same telephone list is available to all drivers. Thus the drivers may not prefer to save their personal numbers on the vehicle. Thus there is a need for some solutions in this regard. The current invention of the Car Intelligence focuses heavily on the integration of the information technology and electronics oriented solutions approach to vehicle manufacturing to provide better experiences for different drivers of a single vehicle like family members, relatives or friends. The current invention will allow different users to use the vehicle providing by providing their password and finger impression on the password panel and finger impression scanning console on the vehicle. The users can then use the personal seating arrangements, mirror arrangements, temperature arrangements and other features without having to think about changing the settings of other drivers. Each driver will see their settings applied when they want to use the vehicle. Moreover, their privacy and other preferences will also be maintained as their data will be isolated from other users. For instance, the telephone list of one user will not be available to other users. Moreover the security of the vehicle against theft will be improved remarkably. The finger impressions will be saved in the vehicle database and only people with registered finger impressions will be able to access and drive it. The finger impression scanning console will open only if the password provided by the driver is matched in the vehicle database. Even if somebody gets access to the driver's password, the finger impression has still to be provided to get access to the vehicle and the finger impression is unique for each person. Thus the current invention will drastically reduce the occurrence of vehicle theft. As such the security measures will considerably improve and different users will also be able to restore their settings and preferences when they use the vehicle.

### SUMMARY OF THE INVENTION

The current invention is the vehicle with the operating system that allows multiple drivers to use the vehicle by authenticating them with their finger impressions which are saved by means of databases installed in the operating system. The vehicle consists of an operating system which saves information of up to five drivers. The vehicle authenticates the drivers by means of finger impression which is a unique parameter for each driver. Upon authentication the driver can utilize the vehicle in an individualized manner. The complete process for the working and features of vehicle is described below.

The vehicle in the current invention consists of an operating system which contains essential information about the drivers of the vehicle and for each driver maintains an individualized list of various utilities like GPS address list, telephone list, music list, settings of the driver seat, temperature for each driver, positioning of mirrors and personalized electronic mail server. The list of utilities is not limited to the items mentioned above and additional utilities can be added to the list for each individual driver. The door of the vehicle is fitted with a password console and a finger impression scanning console locked by means of a metallic shutter. These are used to authenticate the driver of the driver so that the correct settings are applied for the driver. The password and the finger impression of the driver are saved on the database in the operating system on the hard drive of the vehicle. In order to gain access to the vehicle and drive it the driver has to first enter the password on the password keypad. As the driver enters the password on the keypad, it is checked by the controller in the vehicle database. If the password exists in the database, the controller will open the shutter of the finger impression scan console and will prompt the driver to provide the finger impression. When the driver provides the finger impression, the controller will match the finger impression in the database. Upon finding a positive match, the controller will open the vehicle for the driver and will also load the vehicle settings and other services customized by that particular driver. In this manner each of the vehicle drivers will have their own settings for the seat, a list of addresses loaded into the GPS, the music collection, personalized telephone list, steering wheel, mirror adjustment and electronic mail server. The drivers will also be able to connect their computing devices like hand-held computers or laptops with the operating system and download their electronic mails. The electronic mail server will also be helpful in case of attempt of the vehicle theft. The vehicle will save finger impressions for up to five drivers and even five non-drivers like kids under the legal driving age. When the non-drivers will scan their finger impression, the vehicle will recognize them but won't start up or unlock because their status will be set not to drive. If anybody, whose finger impression is not registered with the vehicle, tries to open the vehicle, the vehicle will save the finger impression and electronic mail it to the owner, the security company and the police authorities by the means of the electronic mail server.

### BRIEF DESCRIPTION OF THE DRAWINGS

FIG. 1 overall diagram of the vehicle with a password console and finger impression scanning console locked with a shutter.

FIG. 2a and FIG. 2b shows the password window and the opened Finger Impression scanning console

FIG. 3 shows the flow chart of the process involved in the invention

FIG. 4 describes the Address Location tab settings on the Graphical Display

FIG. 5 describes the Telephone List tab settings on the Graphical Display

FIG. 6 describes the Music List tab settings on the Graphical Display

FIG. 7 describes the Electronic mail tab settings on the Graphical Display

FIG. 8 describes the Car Settings tab setting on the Graphical Display

FIG. 9 describes the Weather tab settings on the Graphical Display

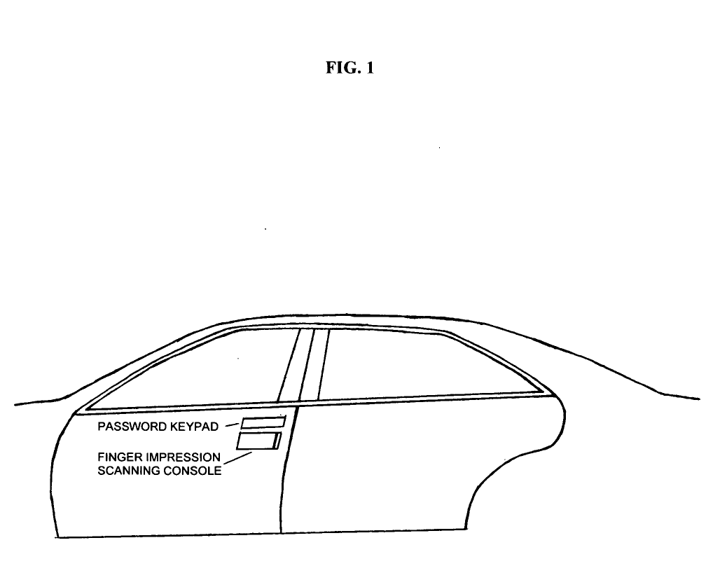

### DETAILED DESCRIPTION OF THE INVENTION

The current invention is comprised of the following components:
a. Password Window on the Driver door of the Car.
b. The Finger Impression Scanner Console with a security shutter on the driver door of the vehicle.
c. The Operator Database.
d. The User Profiles.
e. The Controller Unit.
f. Graphical User Interface.

Function of the Components

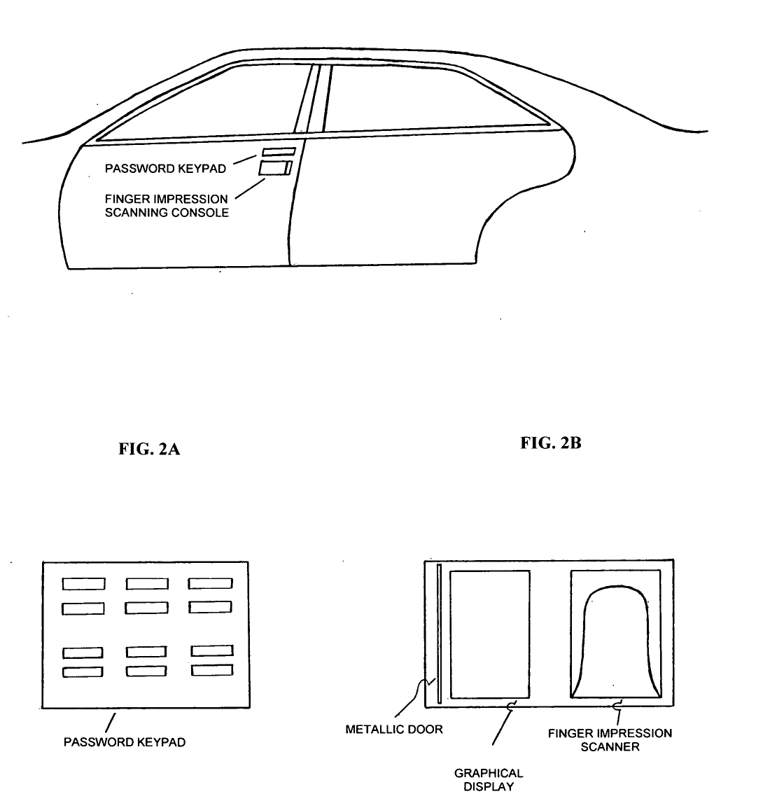

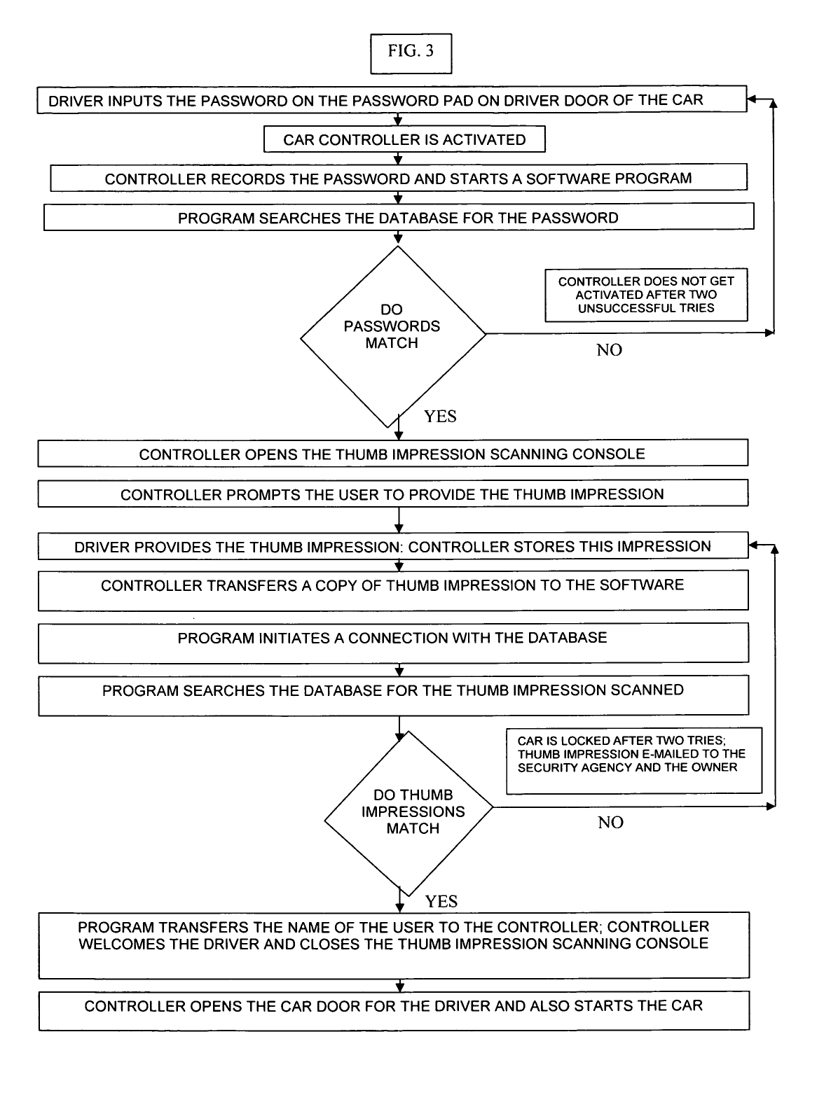

a. Password Window: As shown in FIG. 2a the password window on the driver door of the vehicle is used by the driver to start the vehicle opening process. The driver is required to punch his or her password on the password window console. This password activates controller which checks this password in the database by means of a software program. If matched, this step leads to opening of the finger impression scanning device for the driver to scan the finger impression. The password is stored in the database along with finger impression scan and other information for the driver. If two users have the same password even then the finger impression is unique for them and as such the controller will be able to recognize the right driver and will apply correct settings for that driver.

b. The Finger Impression Scanner Console: The purpose of the finger impression scanner console is to record the finger impression scanned by the driver as shown by FIG. 2b. When the password entered by the driver is matched in the database and the positive result is returned to the controller, the controller opens the metallic security shutter on the driver door of the vehicle. The driver scans the finger impression on the console which is checked in the database. If the finger impression matches a finger impression in the database, the controller will close the console, start the vehicle and open the vehicle door for the driver.

c. The Operator Database. The operator database will maintain information related to all the drivers and will also provide links to the user profiles of the drivers. The Operator database will contain the following information related to the drivers:
1. Finger Impression
2. Driver's Password
3. Drivers First Name
4. Driver's Last Name
5. CarSettings FileName
6. AddressList FileName
7. TelephoneList FileName
8. MusicList FileName

d. The User's Profile. The user profile will contain files with information and preferences of different drivers for features like Car Settings, Address List, Telephone List, Music List and other functions. All the information related to driver preferences will be saved in the files and saved onto the storage media which will be accessed by The Controller Unit. The users will be able to modify these files by means of viewing and changing information through a graphical display. All the users or drivers of the vehicle will have their individual files with their preferences saved. For instance, Driver 1 will have a file with addresses saved under his or her User Profile whereas Driver 2 will have his files saved under his or her User Profile.

e. The Controller Unit. The Controller Unit will act like a central unit which will control the entire process from validating the finger impression of the driver to setting the attributes or preferences of the driver who will be driving the vehicle. The Controller Unit will control the validation of the driver by verifying his password, finger impression recording and matching process, accessing the operator database to locate the user files based on the User Profile and then applying the settings according to the preferences of the driver. The Controller Unit will also control the electronic mail server in order to provide the individualized interface for the drivers to perform their electronic mail related functions. Moreover the Controller Unit will use the electronic mail server to report any act of theft or misuse of the vehicle to the owner and security personnel. When the driver will reach his or her destination and will turn the vehicle off, the Controller Unit will also save the changes made by the driver and then unload the user profile of the current driver and will bring the vehicle attributes to default setting. The Controller Unit will also make sure that no user of the vehicle is able to view information related to the other user unless specified otherwise.

f. Graphical User Display. The Graphical User Display will be the means of performing the complete process involved in the current invention. The user of the vehicle, once verified, will be able to view his or her preferences related to the addresses, phone numbers, music, electronic mail and other features on the screen. The user will be able to control and modify any information like addition or deletion of addresses and telephone numbers by means of the graphical interface.

Process

The process involved in the current invention can be explained in the following six steps:

DRIVER'S PASSWORD: The first step starts with the input of the driver's encrypted password. The driver is required to provide the password on the password window to get access to the finger impression scanning console. When the user provides the password on the password window, the controller unit is activated and it records the password of the driver. The controller unit then activates a program and sends a copy of the password to the program. The program initiates a connection with the vehicle database on the hard drive and searches for the password provided by the driver. If it finds the password as existing in the database, it forwards the result to the controller. The program searches the entire database as multiple drivers can have same password. In either case, the password entered by the driver is a positive match. At this the controller opens the shutter of the finger impression scanning console.

DRIVERS FINGER IMPRESSION: The second step of the process in the current invention is to obtain the finger impression of the vehicle driver in order to verify the identity of the driver. After the passwords have matched, the Controller Unit opens the shutter of the finger impression scanning console and prompts the driver to provide the finger impression scan to verify his or her identity. When the driver scans the finger impression on the device, the Controller Unit captures the impression and provides a copy to the software program. The software program now finds the finger impression in only the entries that contain the same password as entered by the driver. If it finds a match amongst those entries, it will return a positive result to the controller along with the name of the driver who scanned the finger impression. At this the Controller provides the notification on the results portion of the finger impression scanning console and closes it down in order to implement the next step.

DOOR UNLOCK AND START CAR ENGINE: The third step in the current invention is initiated only when the result from the second step is positive. When the password entered by the driver on the console matches with the password stored in the database, the Controller Unit closes the Password Entry Console and unlocks the driver door of the vehicle. After the door is opened, the Controller Unit sends a signal to start the engine of the vehicle. With this the driver can now enter the vehicle without any key and without having to start the vehicle engine. While the starts up, the Controller Unit initiates the next step of the process which is loading the essential vehicle features.

LOAD THE ESSENTIAL CAR FEATURES: Once the verification has been performed and the vehicle started, the Controller Unit of the current invention loads the essential vehicle features for the driver. The Controller Unit initiates a Features Loading Program which installs all the essential features of the vehicle pertaining to the preferences of the driver and forwards a copy of the scanned finger impression to the Features Loading Program. The first feature that the program installs is the vehicle seat settings. The Features Loading Program does this by establishing a connection with the database and searching for the finger impression of the driver. Once the match is found, the Features Loading Program obtains the file path of the vehicle features file for the driver which denoted by DriverName.cfs. Once the Program retrieves the file name, it opens the file from the hard drive of the vehicle and applies the settings customized by the driver. The first vehicle settings to be implemented are the ones for seat arrangement which are customized by the driver. Followed by this, the Features Loading Program loads the settings for mirrors, regulates the temperature for the driver and loads the color scheme of the panel lights and turns them depending upon the time of the day or the prevalent weather conditions.

START THE GRAPHICAL USER INTERFACE AND LOAD THE SERVICES: This step of the current invention involves the startup of the Graphical User Interface by the Controller Unit and then loading the services so as to be utilized by each driver as per their requirements. The Controller Unit initiates a Control Program that loads the tabs for the following, but not limited to, services:
a. AddressList along with GPS Service
b. MusicList with Connection to the Player and Speakers
c. TelephoneList
d. Electronic mail service with connection to PDA/Mobile Device
e. Car Features Tab for making changes to existing seating preferences
f. Weather Tab that to calculate current weather conditions at the point of origin, intermediate distance and the destination and to subsequently provide driving tips to the driver.

As the Controller Unit initiates the Control Program it transfers a copy of the driver finger impression to the Control Program. The Control Program establishes a connection with the database and searches for the files related to the tabs that are loaded on the Graphical User Display. The database returns the files which contain addresses, music files, and telephone list, electronic mail and the vehicle settings for the driver. The names of these files will be as follows:
a. DriverName.AL for the address list of the current driver.
b. DriverName.Mus for the music list of the current driver.
c. DriverName.TL for the telephone list of the current driver.
d. DriverName.eml for the electronic mail list of the current driver.
e. DriverName.cfs for modifying the vehicle setting features for the current driver.

The Control Program will receive the file names from the database and locate the files stored in the driver profile on the vehicle hard-driver. The Control program accesses each of the files for the current driver and load the data contained in the files in the respective tabs on the graphic user interface. The driver will be able to select any tab at any given time based on the function to be performed.

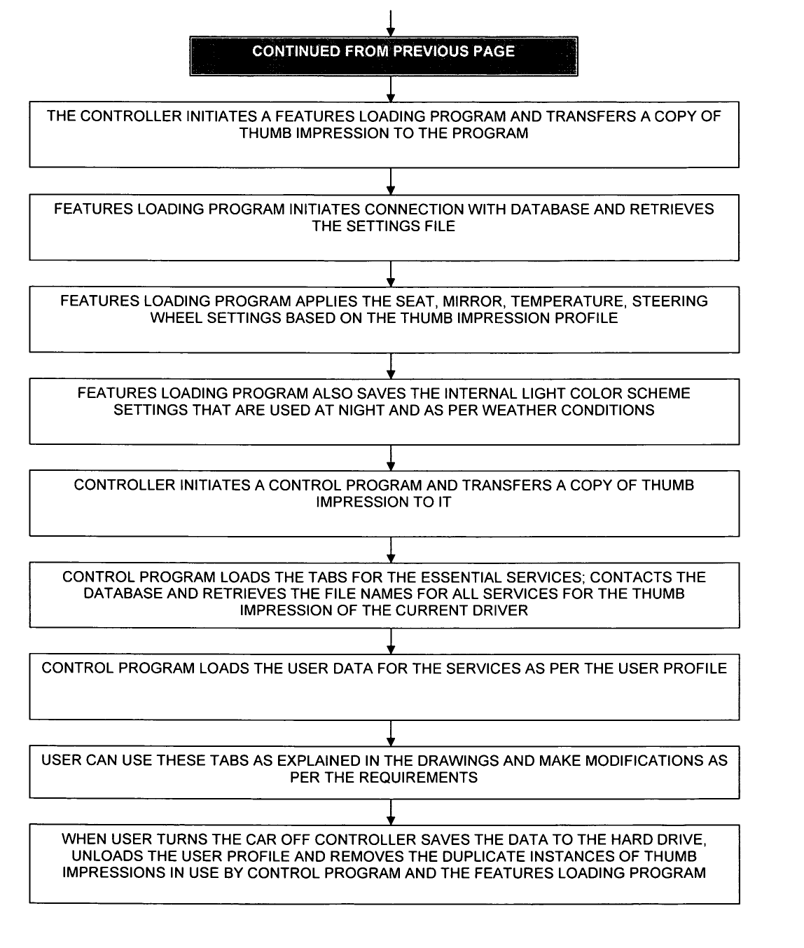

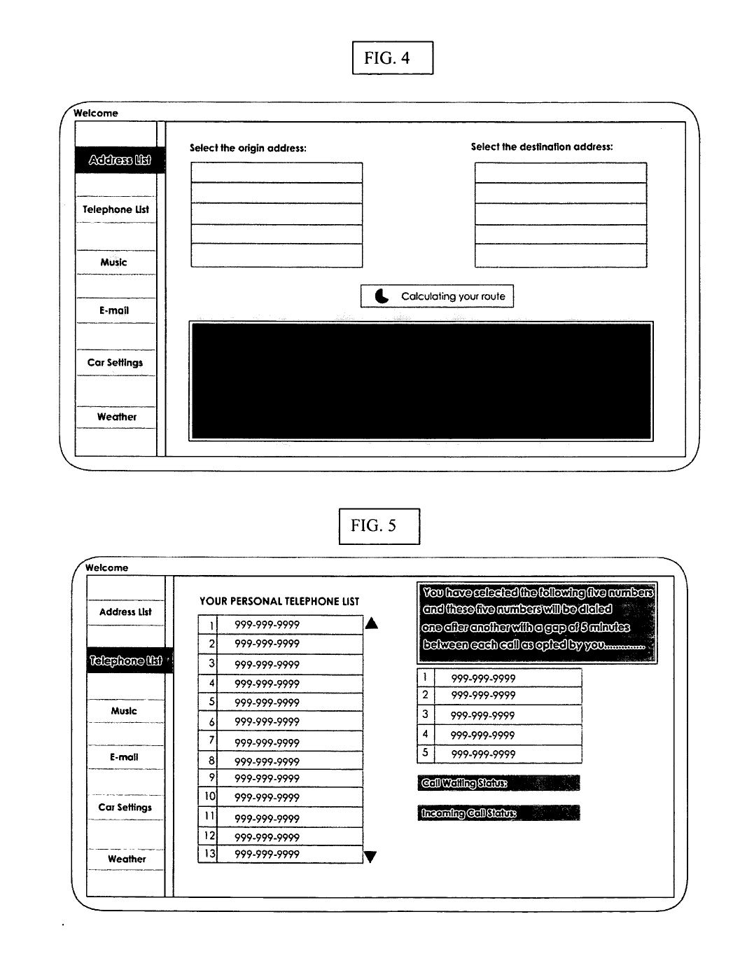

USING THE SERVICES: Once the services are loaded in their respective places, the driver will be able to use each service by means of touch-screen on the graphical user interface. For using the AddressList service, the driver will touch the AddressList tab. As shown by FIG. 4, on the Address List screen, the driver will have to select the origin and destination addresses. If the addresses are already present in the address list, the driver will just have to select the addresses and then to push the “GO” button. If the desired destination address is not present in the address list, the driver will be able to enter the new addresses and save them to the existing list, if required. When the driver pushes the “GO” button, the Global Positioning System will start, calculate the route and start guiding the driver.

The Driver will be able to use the Telephone Tab by selecting it from the Graphical User Display as shown by FIG. 5. When the driver hits the Telephone tab, the screen containing the driver's list of telephone numbers will appear and the driver will be able to select up to five numbers from the list which will be called in the order of selection. The driver will also be able to select the time lapse between each call. After selecting the numbers, the driver will be able to place calls by selecting the “Connect” Button once. If any music is being played at that time, the Control Program will pause the music and will resume playing the music once the call is disconnected. The music will be played during the gap between two calls also. If the driver receives a call during an ongoing call, the details of the incoming call will be displayed on the Telephone tab screen. The driver will be able to use the Hold feature to hold the current call and answer the incoming call. If the driver chooses not to do so he will be prompted to check the missed call and call the missed number when the driver disconnects the current call.

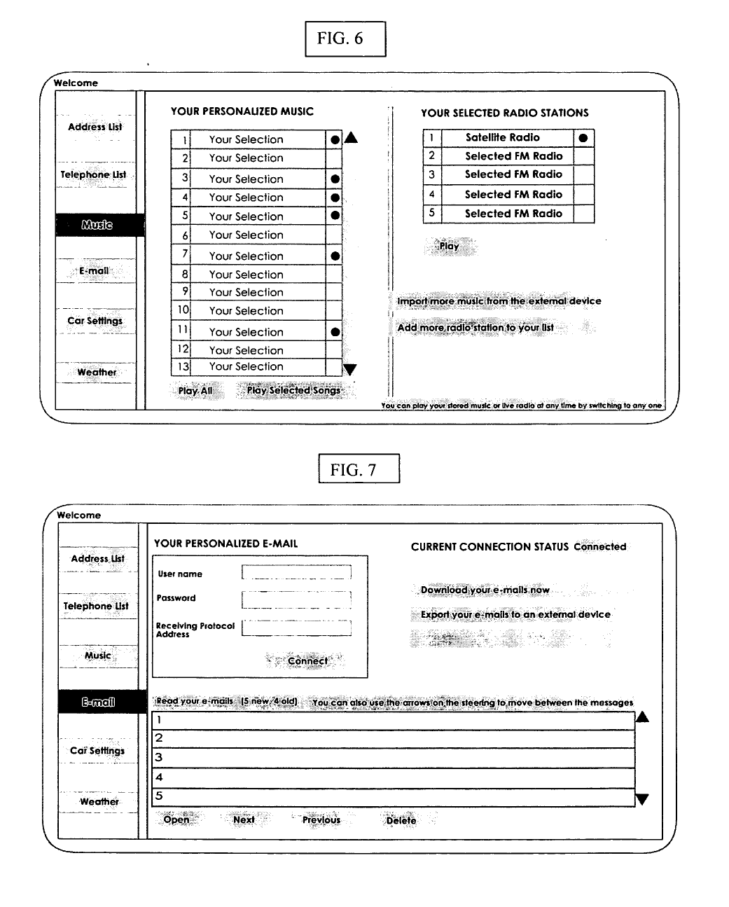

If the driver wants to listen to the music, the driver will have to touch the Music Tab. Once the music tab screen appears as shown by FIG. 6, the driver will see the entire list of songs of his choice that he saved to the hard drive of the vehicle under his or her user profile. The driver will have the choice of playing the entire music list in order of listing, randomly and even playing the selected list. The Music Tab will also display a list of pre-selected radio channels which the driver will be able to listen to just by touching the button on the screen. The Music Tab screen will be divided into two parts, one displaying the customized song list and the other showing the list of pre-selected radio channels. The driver will be able to select only one part at a time which means that the driver will be able to listen to either his own customized song selection or the pre-selected radio channel. The Control Program will also load the speaker settings of the vehicle as saved by the driver so that the driver does not have to select all the speaker options of his choice again.

The Electronic Mail tab shown by FIG. 7 will allow the drivers to download electronic mails from their electronic mail service providers. To download the electronic mails, the driver will select the Electronic mail tab on the Graphical User Interface. A part of screen will display the configuration settings for the electronic mail server including the electronic mail address of the user, the encrypted password for the electronic mail service and the address of the communicating protocols like POP3 address. The Control Program will initiate an internet connection using the Wireless mode of connection. Once the connection is established with the internet, the driver will have to hit the “DOWNLOAD” button on the screen. Once the identity of the electronic mail account is verified by the service provider's system the new electronic mails will be downloaded and displayed on the Graphical User Display. The driver will be able to read his or her electronic mails on the display only or will be able to transfer them to the external device connected to the vehicle.

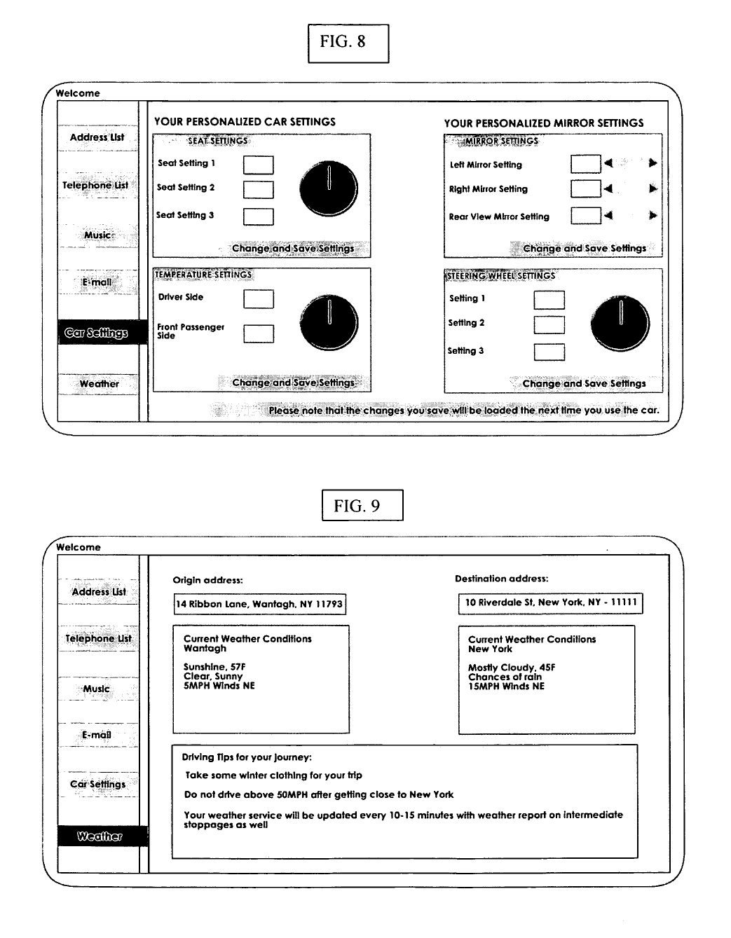

The vehicle features tab will allow each driver to modify or change their current seating arrangements to their liking. When the driver will press on the Car Features tab on the graphic display shown by FIG. 8, the different vehicle settings will be displayed on the screen. Using the touch screen the driver will be able to make changes to those settings. The last set of settings that will be used and saved by the driver will become the current settings for the driver when he or she uses the vehicle next time. Along with seat settings, the driver will also be able to change the settings of the mirrors and the settings of the steering wheel.

The Weather tab will provide information about the current weather conditions at the origin, intermediate distance and the destination. In order to know the weather in key places, the driver will select the Weather tab shown by FIG. 9. Upon this the Control Program will pick the origin and the destination address from the addresses in use by the Address Location tab. Along with this it also picks an intermediate location along the driving directions. The Control program will contact the weather satellite to retrieve information about current weather conditions prevalent in these three places. Based on the weather condition and predicted behavior of weather, the control program will provide tips about driving conditions and other useful information to the driver which might help the driver consider any alternatives in case of severe weather conditions. The weather tab will display information that will be refreshed at regular time intervals.

MODIFYING THE FEATURES AND SERVICES: The current invention enables each driver of the vehicle to make changes to their preference files by means of the Graphical User Interface. The driver can make changes to any or all of the files as per the requirements. The driver will be able to make changes to the address file by amending the DriverName.AL file. The driver can add new address to the list, delete an already existing address or edit the existing address. The Controller Unit records all the modifications to the address file by means of the control program and prompts the user to save the changes just when the driver completes the task. When the driver enters the origin and/or destination address, the Control Program will detect the fact that the address has not been selected from the existing list and it will prompt the driver to save the address in the address list file. The driver will be able to do so by hitting the “Save and Go” button which will enable the Control Program to save the new address in the DriverName.AL file. But if the driver wants to use this address only once, he or she will need to press only “GO” button. This will direct the Global Positioning System to find the directions and the Control Program will not save the address to the DriverName.AL file.

In order to make changes to the Telephone List file, the driver will use the TelephoneList tab on the Graphical User Interface and the changes will be made to the file DriverName.TL on the vehicle hard-drive. The driver will be able to add new contact number, delete an existing number or modify the number. In the case of adding a new number to the list, the driver will be able to add the number when he first dials it on the graphical user interface. Right at the time of placing the call, the driver will be prompted to save the number to the file. The driver will be able to hit the “OK” or “CANCEL” button to respectively save the changes or disvehicled the changes. In order to delete any already existing telephone number the driver will have to sort through the telephone list and select “DELETE” option the graphical user interface screen. In order to edit the number, the driver will have to select the number, press “EDIT AND SAVE” option on the Graphical User Interface and then make changes to existing number. When done with changing the number, the driver will have to select the option “OK” to save the telephone list file on the vehicle hard-drive under his or her user profile.

In case of the music preferences, the driver will be able to add the music files to the profile and delete the music files from the profile but will not be able to edit any music file. The driver will be able to add songs to the existing list from the external detachable media connected to the appropriate player of that media. The list of songs will be displayed on the Music Tab of the Graphical User Interface and the Control program will prompt the driver to copy the songs from the external media to the Music list saved under the user profile. The driver will be able to select all the songs or the selected songs based on the driver's liking of the music. Once the songs are selected the driver will be able to save them on the vehicle hard-drive under his or her user profile. In case of deletion, the driver will go to the list of songs on the graphical user interface, select the songs to be deleted and press the “DELETE AND SAVE” button on the graphical user interface. When the Control program deletes the song, it will save the remaining file under the user profile of the current driver of the vehicle.

In the Electronic mail Tab of the Graphical User Interface, the user will be able to transfer electronic mails to the external device like PDA or a laptop. The driver will have the choice to transfer all the electronic mails to external device or selected electronic mails to the external device. To do so, the driver will go the Electronic mail Tab on the Graphical User Interface and select the “TRANSFER ALL” option on the screen to transfer all the messages to the external device. Alternatively, the driver will also be able to select the messages randomly and transfer them to the external device. If there is no external device connected to the vehicle, these options will appear as inactive on the screen.

SECURITY PROVIDED BY THE SYSTEM: The current invention also provides security and safety for the vehicle by means of a reporting system installed in the vehicle. The vehicle is installed with a default electronic mail server that is activated at the same time as the controller unit. The Controller Unit records the events at the password entry stage and the finger impression scan stage. If a person other than the drivers and family members try to enter the password on the vehicle and enter it wrong, the controller unit will not open the finger impression scanning console and will just record the passwords entered on the password keypad. The Controller unit will allow two such tries by any individual. After two unsuccessful attempts, the controller will lock the password keypad so that it cannot be used by anyone for multiple minutes. The controller unit also contacts the electronic mail server and sends an electronic mail to the owner of the vehicle and the security agency. For enhanced security, the owner of the vehicle will also be able to disable and enable the password keypad as and when required in order to prevent anyone from entering the passwords on the keypad by usage of a specific length activator phrase in addition to the driver password. If the keypad is locked and needs to be unlocked, the activator phrase will need to be entered to activate the keypad. This feature will usually be useful at times when the vehicle is not frequently used.

In another case, if anyone other than the drivers is able to get the activator phrase and driver password correct, the Controller Unit will open the finger impression scanner console for that person. If the person attempts to scan his or her finger impression on the console, it will be stored by the controller unit. Since this impression will not be in the database of the vehicle, the negative result will be returned by the software program to the Controller Unit. The Controller unit will allow another attempt to the current user. If the same negative results are returned by the software program to the Controller Unit, the controller unit will lock the password keypad and the finger impression scanner console so that they cannot be used until the issue is resolved. The controller Unit will then check the finger impressions scanned on the console and if they are same it will send one copy of the finger impression scan electronically to the vehicle owner and the security agency for their action. If the controller unit determines that the finger impression scanned on the console were different, it will send both the finger impression scans to the owner and the security agency.

OWNER PRIVELEGES: The owner of the vehicle will be able to set the privileges for other drivers of the car. The owner will be able to set the following set, but not limited to, of privileges for different drivers:
a. Deciding the driving times for other drivers.
b. Enabling or disabling the user profiles of other drivers.
c. Setting the specific times when other drivers will not be able to use the vehicle. This will be specifically useful when the owner will need the vehicle for his or her own individual use.
d. To enable a designated user for one-time use only.

What is claimed is:

1. A multiple wheel vehicle comprising of:
the driver's door fitted with an electronic keypad for entering the password, the keypad containing buttons for numerals and alphabets and transmitting the password;
the said driver's door installed with a graphical display or scanning device to scan the finger impressions of different drivers, the said graphical display or scanning device being shielded by a rectangular metallic door cover that opens automatically when the password entered on the keypad is correct;
a hard drive to store the operating system, database, user profiles and multiple types of files related to different drivers of the vehicle.

2. The multiple wheel vehicle of claim 1 further comprising:
a controller unit that controls the entire process of driver verification by comparing the password entered by the driver on the said electronic keypad with the password in the vehicle database by means of an operating system and a software program installed on the said hard-drive;
the said controller unit opening the said rectangular metallic door cover shielding the said finger impression scanning device upon verification of the passwords and prompting the driver of the vehicle to provide the finger impression scan;
the said controller unit comparing the finger impression provided by the driver with the finger impression in the vehicle database by means of said operating system and a software program;
the said controller unit closing the said rectangular metallic door cover shielding the finger impression scanning device after the finger impressions have been matched, opening the vehicle door for the driver by means of an automatic lock release device and turning the vehicle on for the driver.

3. The said controller unit of claim 2 further containing:
a preferences loading program that contains a copy of the finger print impression of the driver, searches the said database on the said hard-drive for the vehicle preferences file name for the driver, the said preferences loading program loading the customized vehicle-seat settings, mirror settings, temperature settings, panel light settings and speaker settings for the driver;
a control program that starts after the vehicle settings have been applied, contains a copy of the finger print impression of the driver, searches the said database for customized file names related to address locations, telephone numbers, music files, electronic mail and search these files on the said hard-drive saved under the driver's user profile located on the said operating system, starts the graphic display inside the vehicle and loads the service tabs for the said customized address location file, telephone numbers file, music files, electronic mail file and live service for weather updates at the origin, intermediate location and destination addresses for the driver of the vehicle, the said files being able to be modified by the driver at any time;
a termination program to save all the settings changed by the driver and save them on the said hard-drive under the said user-profile when the driver turns the vehicle off in order to reinstate same settings for the driver next time.

4. The Controller Unit of claim 1 further controlling:
the said electronic keypad that can be disabled when the password entered by the driver does not match the password in the vehicle database for multiple consecutive times, the unsuccessful passwords being mailed to the owner and security agency by means of said electronic mail server;
the said keypad that is activated by means of entering a activator phrase by the vehicle owner before entering the password, the said keypad disabled by entering the incorrect password multiple consecutive times or by the owner;
the said finger impression scanner console that is closed when the finger impression scanned by the user does not match the finger impression in the vehicle database, the finger impressions scanned by the user mailed electronically to the owner and the security agency by means of electronic mail server, the multiple finger impression being mailed electronically if they all are different or a single finger impression being mailed electronically if they all are same.

5. The said graphic display of claim 1 further comprising:
the address list tab customized for the driver to select the origin and destination address to provide the navigation to the driver by means of global positioning system, the said address list file being used to display the current settings in use by the driver;
the telephone list tab customized for the driver, the driver being able to add, edit or delete the numbers from the list, and to select multiple numbers that can be automatically called one after another with the time interval between two calls specified by the driver, the said telephone list file being used by to display the list of numbers for the driver driving the vehicle;
the music list tab customized for the driver containing a list of music files and radio channels, the driver being able to save multiple music files on the said hard-drive of the vehicle by means of an interface to connect with an external device, remove the music, and to play all or selected music or radio, the said music list file being used to display all the songs and the list of radio stations for the driver;
the electronic communication tab customized for the driver to receive electronic communication by means of wireless communication; the driver being able to export these communication to external devices by means of an interface to connect with an external device, the said electronic mail file being used to display the electronic mail for the driver and options to receive new electronic mail;
the weather services tab that will use the origin and destination address from the said address list and display the current weather conditions at origin, intermediate location and destination for the driver along with the driving tips.
